(19) United States
(12) Patent Application Publication
(10) Pub. No.: US 2026/0313400 A1
(43) Pub. Date: Oct. 8, 2026

(54) SYSTEMS AND METHODS FOR GRANULAR QUALITY OF SERVICE MAINTAINABILITY ANALYTICS REPORTING IN A WIRELESS NETWORK

(71) Applicant: Verizon Patent and Licensing Inc., Basking Ridge, NJ (US)

(72) Inventors: Peretz Feder, Englewood, NJ (US); Violeta Cakulev, Milburn, NJ (US); Egemen Kemal Çetinkaya, Hillsborough, NJ (US)

(73) Assignee: Verizon Patent and Licensing Inc., Basking Ridge, NJ (US)

(21) Appl. No.: 19/171,539

(22) Filed: Apr. 7, 2025

(51) Int. Cl. H04W 24/04; H04L 41/14; H04W 24/10; H04W 28/02

(52) U.S. Cl. CPC H04W 24/04; H04L 41/14; H04L 41/5009; H04L 41/5025; H04L 41/5067; H04L 43/08; H04W 24/08; H04W 24/10; H04W 28/0268

(57) ABSTRACT

A device, such as a Network Data Analytics Function (“NWDAF”) of a wireless network, may determine QoS maintainability analytics associated with a particular Quality of Service (“QoS”) identifier over a particular timeframe. The one or more QoS maintainability analytics may include bitrate, latency, and/or packet error rate of traffic associated with the particular QoS identifier over the particular timeframe. The device may receive, from a second device, a QoS maintainability analytics request that specifies the particular QoS identifier and is associated with the particular timeframe. The device may generate a QoS maintainability analytics report based on the QoS maintainability analytics associated with the particular QoS identifier over the particular timeframe; and provide the QoS maintainability analytics report to the second device, which may modify one or more configuration parameters associated with one or more network services provided by the second device based on the QoS maintainability analytics report.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may include Network Functions (“NFs”) that perform various operations relating to providing network services such as routing, authentication, Quality of Service (“QoS”) management, or the like. Some wireless networks include an NF that generates analytics information, such as performance information, congestion information, or the like, such as a Network Data Analytics Function (“NWDAF”). The analytics information may be historical (e.g., based on information measured or determined in the past), and/or may be predictive (e.g., based on applying predictive model-based techniques, artificial intelligence/machine learning (“AI/ML”) techniques, or the like). In some wireless networks, an NWDAF determines or provides analytics information such as QoS sustainability analytics that are based on factors such as radio access network (“RAN”) User Equipment (“UE”) throughput (e.g., average UE bitrate in a cell of a RAN), delay in RAN (e.g., uplink and/or downlink latency of communications between a RAN and a UE), and QoS flow retainability (e.g., based on a number of abnormally released QoS flows during a given timeslot). The NWDAF may provide such analytics information to other NFs of the wireless network (e.g., “consumer NFs”), which may use the analytics information to coordinate or configure the manner in which such NFs provide their respective services.

### BRIEF DESCRIPTION OF THE DRAWINGS

FIG. 1 illustrates an example overview of one or more embodiments described herein;

FIG. 2 illustrates example QoS maintainability analytics requests, in accordance with some embodiments;

FIG. 3 illustrates an example of monitoring or obtaining QoS maintainability analytics information, in accordance with some embodiments;

FIG. 4 illustrates an example of reconfiguring a RAN based on QoS maintainability analytics information, in accordance with some embodiments;

FIG. 5 illustrates an example of reconfiguring services provided to a UE based on QoS maintainability analytics information, in accordance with some embodiments;

FIG. 6 illustrates an example process for generating and providing granular QoS information (e.g., QoS maintainability analytics) in a wireless network, in accordance with some embodiments;

FIGS. 7 and 8 illustrate example environments in which one or more embodiments, described herein, may be implemented;

FIG. 9 illustrates an example arrangement of a radio access network (“RAN”), in accordance with some embodiments;

FIG. 10 illustrates an example arrangement of an Open RAN (“O-RAN”) environment in which one or more embodiments, described herein, may be implemented; and

FIG. 11 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for a more granular and dynamic technique for generating and providing network analytics in a wireless network. For example, as discussed below, a NWDAF of some embodiments may generate and provide a type of analytics information that is referred to herein as “QoS maintainability analytics.” Although the term “QoS maintainability analytics” is used herein, in practice other suitable terms may be used to implement the concepts described herein.

The QoS maintainability analytics may be used by NFs of the wireless network to reconfigure certain parameters (e.g., in order to increase the ability of the wireless network to meet certain QoS thresholds at a given time or location), or by devices or systems external to the network, such as application service provider systems that provide services to one or more UEs via the wireless network. An application service provider system may, for example, modify application-layer parameters (e.g., bitrate, framerate, codec, etc.) and/or other parameters to account for a degradation in the ability of the wireless network to provide a given threshold QoS at a given time and/or location. QoS maintainability analytics may include historical analytics (e.g., as measured, determined, collected, etc. in the past) and/or predictive analytics (e.g., as generated or determined using predictive techniques, AI/ML techniques, or the like). As another example, QoS maintainability analytics may be used to modify the deployed configurations of RANs (e.g., to provide additional coverage at certain locations, implement particular scheduling parameters, etc.) and/or to aid in the deployment of wireless network infrastructure equipment or systems at certain locations (e.g., locations that frequently experience degraded ability of the wireless network to meet one or more QoS thresholds).

QoS maintainability analytics, as discussed herein, may indicate the ability of the wireless network to provide at least a threshold measure of QoS for a given timeframe and/or at a given location. QoS maintainability analytics, as discussed herein, may be determined or provided on the basis of different sets of QoS thresholds (e.g., Service Level Agreements (“SLAs”)), such as sets of QoS thresholds represented or indicated by respective QoS identifiers (e.g., values, pointers, indexes, etc. that represent such sets of QoS thresholds). Examples of such QoS identifiers may include 5G QoS Identifier (“5QI”) values, Network Slice Selection Assistance Information (“NSSAI”) values, Differentiated Services Code Point (“DSCP”) values, and/or some other type of suitable value. In some embodiments, QoS maintainability analytics may indicate a measure of degradation or deviance from a particular set of QoS parameters (e.g., from QoS parameters associated with a particular 5QI value, a particular network slice SLA, DSCP attributes associated with a particular DSCP marking, etc.). In some embodiments, QoS maintainability analytics may indicate a proportion or amount of a particular timeframe (e.g., 25% of the timeframe, 50% of the timeframe, the whole timeframe, etc.) during which the wireless network was able to provide at least a threshold measure of QoS.

In some embodiments, QoS maintainability analytics associated with a particular QoS identifier may include or may be based on QoS parameters such as bitrate (e.g., uplink and/or downlink bitrate of traffic that is associated with the QoS identifier), latency or delay (e.g., uplink and/or downlink latency of traffic that is associated with the QoS identifier), packet error rate (“PER”), and/or other suitable factors. In some embodiments, different QoS maintainability analytics reports (e.g., responses provided by NWDAF for QoS maintainability analytics) may be tailored based on weights or parameters specified in requests for such reports. For example, a first request may specify a relatively high weight for bitrate, and a relatively low weight for PER. A QOS maintainability analytics report that responds to the first request may include a score or other suitable value that is more heavily based on bitrate metrics and is less heavily based on PER metrics. On the other hand, a second request may specify a relatively low weight for bitrate, and a relatively high weight for PER. A QoS maintainability analytics report that responds to the second request may include a score or other suitable value that is less heavily based on bitrate metrics and is more heavily based on PER metrics.

In some embodiments, QoS maintainability analytics may be used as a factor in determining one or more other types of analytics, such as QoS sustainability analytics. For example, in some embodiments, QoS sustainability analytics information (e.g., as generated and provided by an NWDAF) may be determined based on QoS maintainability analytics information, such as QoS maintainability analytics reports, QoS maintainability analytics KPIs, etc. In some embodiments, QoS sustainability analytics information (and/or other analytics information determined or provided by an NWDAF) may be determined based on QoS maintainability analytics, without being based on QoS flow retainability analytics. On the other hand, in some embodiments, QoS sustainability analytics information (and/or other analytics information determined or provided by an NWDAF) may be determined based on QoS maintainability analytics in addition to QoS flow retainability analytics.

In some embodiments, QoS maintainability analytics may be determined or represented as a function of QoS thresholds associated with particular QoS parameters (e.g., as a measure of deviation or difference from such parameters). For example, QoS maintainability analytics of some embodiments may indicate or may be based on a determination that the bitrate for a given 5QI has deviated from (or is likely to deviate from) a threshold bitrate associated with the 5QI by 10%, by 20%, or by some other measure. In some embodiments, QoS maintainability analytics of some embodiments may include a composite or combined score, value, or measure of deviation that is based on multiple factors, as discussed above. Further, the composite of combined score, value, or measure of deviation may be based on applying weights for different factors, as specified in a request for QoS maintainability analytics.

In some embodiments, the QoS maintainability analytics may be independent of QoS flow retainability analytics. That is, in some embodiments, a set of QoS maintainability analytics may not include or may not otherwise be based on QoS flow retainability analytics, and/or may not otherwise be based on a quantity of abnormally released QoS flows during a given timeslot. As such, in some embodiments, QOS maintainability analytics may be considered as excluding QoS flow retainability analytics or other analytics information that are based on a quantity of abnormally released QoS flows. In this manner, the QoS maintainability analytics may be more useful to elements of the wireless network and/or to application service provider systems that are communicatively coupled to the wireless network, inasmuch as the QoS maintainability analytics may be tied to metrics that indicate the potential QoS degradation of certain elements or in certain locations of the wireless network. In contrast, implementations that rely, on or require, QoS flow retainability analytics be of limited ability to indicate “degraded” QoS performance versus “failed” QoS performance (e.g., no connectivity during certain periods). Determining and providing QoS maintainability analytics that indicate the degradation, but not necessarily the failure, of the wireless network may thus improve the wireless network's ability to more reliably provide a threshold level of QoS, thereby enhancing the user experience and performance of the wireless network.

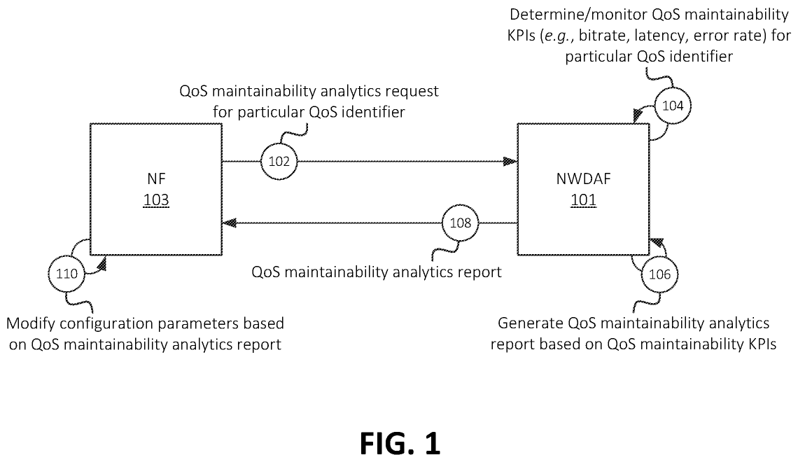

FIG. 1 illustrates an example of an example NWDAF 101, of a wireless network, providing QoS maintainability analytics in response to a QoS maintainability analytics request. In the example of FIG. 1, the QoS maintainability analytics request is received (at 102) from a particular NF 103 of the wireless network. In other examples, QoS maintainability analytics requests may be received from some other suitable device or system, such as a device or system that is external to the wireless network (e.g., an Application Function (“AF”), an application server, a content provider system, or the like).

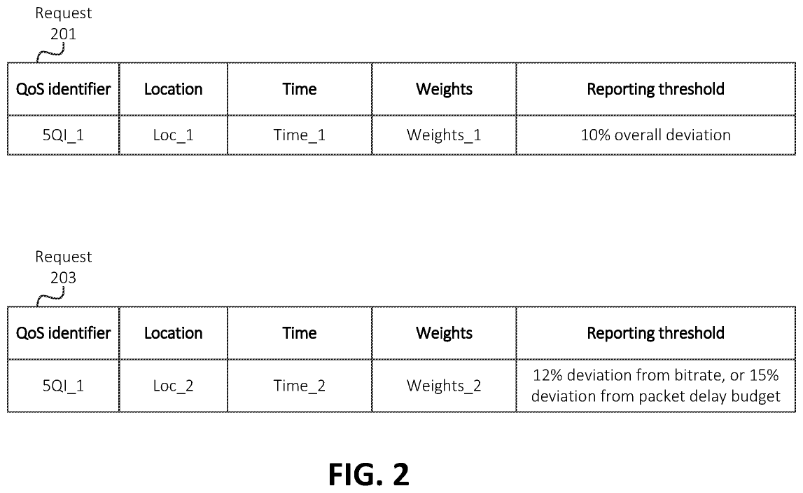

FIG. 2 illustrates two example requests 201 and 203. In this example, requests 201 and 203 may specify conditions or parameters for which QoS maintainability analytics are being requested. For example, such conditions or parameters may include a QoS identifier (e.g., a 5QI value, an NSSAI value, a DSCP value, etc.), a location parameter, a time parameter, a set of weights, and/or a reporting threshold. The location parameter may specify one or more geographical regions, one or more cells or coverage areas of a RAN of the wireless network, and/or may otherwise specify a particular location of interest. The time parameter may specify a past or future timeframe, such as a particular timeframe for which the QoS maintainability analytics (e.g., historical and/or predictive analytics) are being requested. The set of weights for a given request may specify weights to apply to different factors (e.g., bitrate, latency or delay, and/or PER) based on which the QoS maintainability analytics are determined.

The reporting threshold for a given request may specify conditions based on which QoS maintainability analytics should be provided to a requestor (e.g., to NF 103). In the example of FIG. 2, the reporting threshold for request 201 indicates that a QoS maintainability analytics report should be provided when there is at least a 10% deviation in overall QoS maintainability analytics (e.g., a score or value that is determined based on multiple QoS parameters or factors such as bitrate, latency or delay, and/or PER) is identified, as compared to a baseline or threshold measure of QoS maintainability analytics (e.g., a minimum QoS maintainability threshold score).

On the other hand, the reporting threshold for request 203 indicates that a QoS maintainability analytics report should be provided when there is at least a 12% deviation from a threshold bitrate (e.g., a threshold bitrate represented by or associated with a given QoS identifier), or when there is at least a 15% deviation from a packet delay budget (“PDB”) associated with the QoS identifier. That is, reporting thresholds may, in some embodiments, be specified based on individual factors based on which the QoS maintainability analytics are determined.

Requests 201 and 203 may additionally specify whether the requests are a “request-response” type request (e.g., a request based on a response is generated and provided, and the request then considered as completed) or a “subscription” type request (e.g., a request based on which NWDAF 101 continues to monitor QoS maintainability analytics for a given set of QoS parameters (e.g., QoS parameters represented by a given QoS identifier) and push information to NF 103 when the reporting threshold is met). In one example, monitoring QoS maintainability analytics may include determining a measure of degradation or deviation (e.g., from one or more QoS thresholds) on multiple time windows or timeframes. In one example, in a ten-second time window, NWDAF 101 may determine ten such measures of degradation or deviation (e.g., one measure per one-second timeframe of the ten-second time window).

In scenarios where requests 201 and/or 203 are a “request-response” type request, the reporting threshold may be used to determine what types of information to provide in response to the request. For example, if the reporting threshold for a “request-response” type request is not met, this may indicate that the QoS parameter has been, or will be able to be, met for the requested time and/or location, and the response may indicate a positive indication that indicates that the QoS parameter is met for the requested time and/or location.

On the other hand, in situations where the reporting threshold for a “request-response” type request is met, the response may include information not necessarily included in a positive response as discussed above. The additional information may include, for example, a measure of deviation of one or more metrics (e.g., bitrate, latency or delay, or PER) from thresholds specified for the given QoS parameter, a measure of deviation of an overall QoS maintainability score that is based on some or all of the metrics, and/or other suitable information that may be used to identify a degree to which performance of the wireless network has degraded with respect to the particular QoS parameter.

Returning to FIG. 1, NWDAF 101 may determine (at 104) and/or monitor QoS maintainability analytics Key Performance Indicators (“KPIs”) based on the QoS maintainability analytics request (e.g., request 201, request 203, and/or some other request). For example, NWDAF 101 may determine bitrate KPIs associated with traffic, associated with a particular QoS identifier (e.g., associated with a particular 5QI value, a particular NSSAI value, a particular DSCP value, etc.), during a particular timeframe and/or at a particular location (e.g., traffic sent to or received from UEs located at the particular location) indicated in the request. NWDAF 101 may further determine latency and/or delay KPIs associated with such traffic, and/or PER KPIs associated with such traffic.

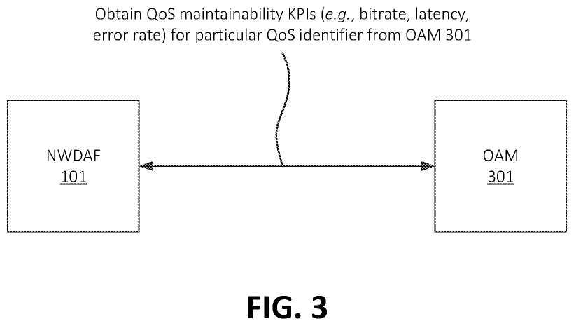

In some embodiments, NWDAF 101 may request or otherwise obtain some or all of the QoS maintainability KPIs (e.g., bitrate, latency or delay, and/or PER) from a device or system that communicates with NFs of the wireless network in order to monitor, aggregate, and/or otherwise determine such KPIs. For example, as shown in FIG. 3, NWDAF 101 may obtain some or all of the QoS maintainability KPIs from Operations, Administration, and Maintenance (“OAM”) system 301. In some embodiments, latency or delay KPIs may include or may be based on RAN latency or delay KPIs (e.g., uplink and/or downlink latency via a RAN of the wireless network) and/or core latency or delay (e.g., uplink and/or downlink latency via a core of the wireless network).

Returning to FIG. 1, NWDAF 101 may generate (at 106) a QoS maintainability analytics report based on the QoS maintainability analytics KPIs. As noted above, the QoS maintainability analytics report may further be based on one or more weights associated with a given QoS maintainability analytics request. For example, NWDAF 101 may identify QoS thresholds associated with the request (e.g., represented by a QoS identifier included in the request). Such QoS thresholds associated with a particular QoS identifier such as a particular QFI value may include, for example, a minimum bitrate associated with the particular QFI value, a PDB associated with the particular QFI value, and/or a maximum PER associated with the particular QFI value. NWDAF 101 may determine a measure of deviation or degradation of QoS maintainability analytics KPIs with respect to their respective thresholds. For example, a bitrate that exceeds a minimum bitrate may be determined as having zero deviation or degradation, while a bitrate that is 10% lower than the minimum bitrate may be determined as having a 10% deviation or degradation.

Additionally, NWDAF 101 may generate a combined QoS maintainability analytics score that is based on the measure of deviation or degradation of some or all of the QoS maintainability analytics KPIs. As discussed above, this combined QoS maintainability analytics score may be weighted more or less heavily for certain QoS maintainability analytics KPIs, based on parameters specified in the request.

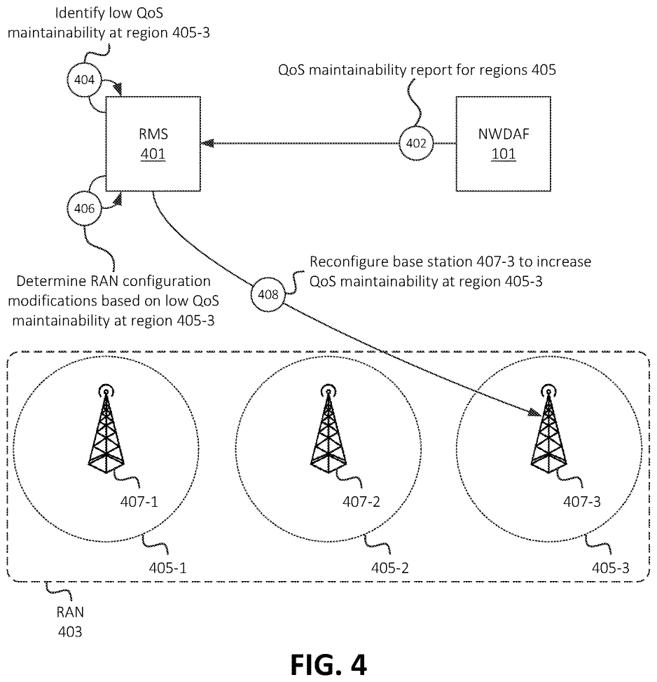

NWDAF 101 may provide (at 108) the QoS maintainability analytics report to NF 103, in response to the QoS maintainability analytics request. As discussed above, NWDAF 101 may provide (at 108) the QoS maintainability analytics report as a one-time response to the request, and/or may provide the QoS maintainability analytics report as part of an ongoing monitoring that is based on a “subscription” type request (e.g., where the QoS maintainability analytics report may be provided when a reporting threshold in the request is met). NF 103 may utilize the QoS maintainability analytics report in order to, for example, modify (at 110) configuration parameters of NF 103 and/or of other NFs, such as in situations where the QoS maintainability analytics report indicates a degradation of the network's ability to meet the appropriate QoS thresholds associated with a given QoS identifier and/or other conditions specified in the request (e.g., a bitrate threshold associated with the QoS identifier, a PDB associated with the QoS identifier, PER thresholds associated with the QoS identifier, temporal conditions, location-based conditions, etc.). For example, NF 103 may modify resource allocation parameters (e.g., to allocate or provision additional resources to providing service associated with the QoS identifier), modify scheduling parameters (e.g., to prioritize traffic associated with the QoS identifier), RAN radio resource parameters, RAN beamforming parameters, and/or other types of parameters in order to mitigate conditions that contribute to the degradation of the ability of the wireless network to provide services according to specified QoS parameters (e.g., QoS parameters that are represented by or otherwise associated with respective QoS identifiers) As shown in FIG. 4, for instance, RAN Management System (“RMS”) 401 may receive a QoS maintainability analytics report and may implement modified RAN configuration parameters based on one or more scores, measures of deviation from respective QoS thresholds, QoS maintainability analytics values, or other suitable information included in the QoS maintainability analytics report. RMS 401 may, for example, include a RAN controller or other type of device or system that configures, manages, etc. elements of RAN 403. In some embodiments, RAN 403 may include, may implement, may be implemented by, etc. an O-RAN. In such embodiments, RAN 403 may include one or more controllers of the O-RAN, such as a Non-Real Time RAN Intelligent Controller (“RIC”) and/or a Near-real Time RIC.

RAN 403 may provide wireless coverage in multiple geographical regions (e.g., different neighborhoods, cities, states, provinces, cells, sectors, etc.), such as regions 405-1, 405-2, and 405-3. In some embodiments, elements of RAN 403 may include one or more base stations 407, such as example base stations 407-1, 407-2, and 407-3. In this example, one base station 407 is shown for each respective region 405. In practice, a particular region 405 may include or may be served by multiple base stations 407, and/or a particular base station 407 may serve multiple regions 405.

RMS 401 may receive (at 402) a QoS maintainability analytics report for one or more regions 405, such as regions 405-1, 405-2, and/or 405-3. In some embodiments, communications between RMS 401 and NWDAF 101 may be routed, forwarded, relayed, etc. by or via one or more other NFs of the network, such as a Network Exposure Function (“NEF”), an Access and Mobility Management Function (“AMF”), and/or other some other NF. As discussed above, RMS 401 may have provided a QoS maintainability analytics request to NWDAF 101, which may include a “request-response” type request or “subscription” type request. NWDAF 101 may accordingly generate the QoS maintainability analytics report in accordance with information provided in the request, such as QoS maintainability analytics information associated with a particular QoS identifier and one or more regions 405 during a given timeframe.

RMS 401 may identify (at 404) a relatively low measure of QoS maintainability at a particular region 405, such as region 405-3 in this example. For example, RMS 401 may identify that an overall QoS maintainability analytics score for region 405-3, as indicated in the QoS maintainability analytics report, is below a threshold QoS maintainability analytics score. As another example, RMS 401 may identify that one or more measures of deviation of one or more QoS maintainability analytics KPIs, as indicated in the QoS maintainability analytics report, are greater than a threshold deviation from corresponding QoS thresholds, as discussed above.

RMS 401 may further determine (at 406) one or more configuration modifications based on the identification of the relative low measure of QoS maintainability at region 405-3. For example, RMS 401 may apply one or more AI/ML techniques or other suitable automated techniques to determine configuration modifications for base station 407-3, such as radio resource allocation parameters, scheduling parameters, beamforming parameters, or other suitable configuration parameters. In general, such configuration parameters may be modified in order to improve the capability of base station 407-3 to provide service according to one or more QoS thresholds, SLAs, etc. (e.g., QoS thresholds or SLAs associated with a 5QI value, a NSSAI value, a DSCP value, etc.) specified in the QoS maintainability analytics request to UEs located in region 405-3. RMS 401 may accordingly reconfigure (at 408) base station 407-3, of region 405-3, based on the RAN configuration modifications. For example, RMS 401 may provide reconfiguration instructions via a suitable control channel, such that base station 407-3 is able to receive and implement such configuration modifications.

In some embodiments, another device or system associated with RAN 403 may receive QoS maintainability analytics reports (e.g., from RMS 401, from NWDAF 101, and/or from some other suitable source). For example, a RAN planning system may receive QoS maintainability analytics reports associated with a given region 405, and may determine that additional wireless network infrastructure equipment (e.g., additional base stations 407) should be deployed within or proximate to the given region 405.

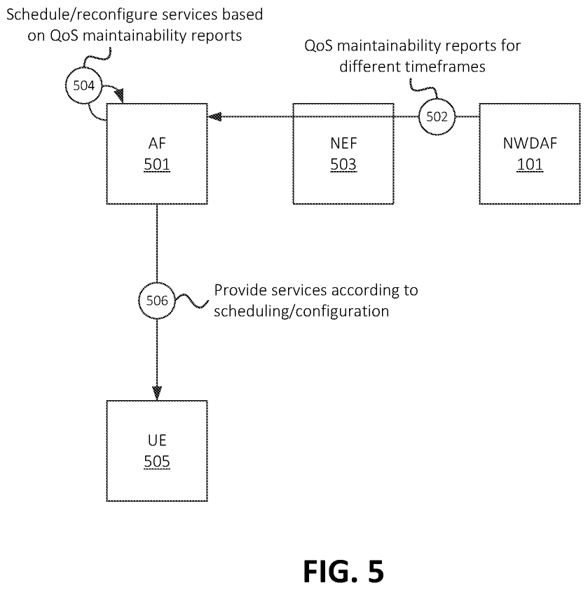

FIG. 5 illustrates an example embodiment in which an external device (e.g., AF 501) receives one or more (at 502) QoS maintainability analytics reports (e.g., via NEF 503) from NWDAF 101. The QoS maintainability analytics reports may, in some scenarios, correspond to multiple different timeframes. For example, a first QoS maintainability analytics report may correspond to a first one-hour timeframe on a certain day (e.g., 12:00-1:00), a second QoS maintainability analytics report may correspond to a second one-hour timeframe on the same day (e.g., 1:00-2:00), a third QoS maintainability analytics report may correspond to a third one-hour timeframe on the same day (e.g., 2:00-3:00), and so on.

AF 501 may schedule and/or reconfigure (at 504) services based on the QoS maintainability analytics reports. Services provided by AF 501 may include services provided via the wireless network to one or more UEs 505, such as voice call services, videoconferencing services, gaming services, content streaming services, augmented reality (“AR”) services, automated guided vehicle (“AGV”) control services, automated surgical robot control services, and so on. AF 501 may, for example, modify parameters such as bitrate, codec, burst interval, or the like, in order to account for reduced ability of the network to meet certain QoS thresholds at certain future times (e.g., as indicated in the QoS maintainability analytics reports) and/or at particular locations (e.g., regions 405). As another example, AF 501 may disable certain services, such as mission-critical or latency-sensitive services (e.g., automated guided vehicle (“AGV”) control services or automated surgical robot control services) that are unable to be used with reduced or relaxed QoS thresholds, during times and/or at locations at which the network is not predicted to be able to meet QoS thresholds associated with such services.

AF 501 may proceed to accordingly provide (at 506) services to UE 505 in accordance with the determined scheduling and/or modified configuration. For example, AF 501 may modify bitrates, codecs, or other aspects of the services provided to UE 505, where such modifications may be associated with a second QoS identifier that has lower QoS requirements as compared to a previously specified first QoS identifier. As another example, AF 501 may indicate (e.g., to UE 505) times and/or locations at which QoS thresholds associated with a given QoS identifier are able to be met by the network.

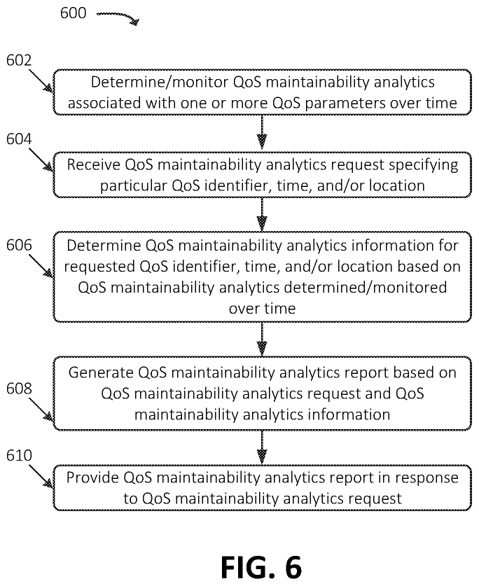

FIG. 6 illustrates an example process 600 for generating and providing granular QoS information (e.g., QoS maintainability analytics) in a wireless network. In some embodiments, some or all of process 600 may be performed by NWDAF 101. In some embodiments, one or more other devices may perform some or all of process 600 in concert with, and/or in lieu of, NWDAF 101.

As shown, process 600 may include determining and/or monitoring (at 602) QoS maintainability analytics associated with one or more QoS identifiers over time. For example, NWDAF 101 may monitor QoS maintainability analytics information associated with traffic that is associated with one or more QoS identifiers. As discussed above, the QoS maintainability analytics information may include bitrate metrics (e.g., uplink and/or downlink bitrate via a core network and/or a RAN), latency or delay metrics (e.g., uplink and/or downlink latency or delay via the core network or the RAN), PER metrics (e.g., uplink and/or downlink PER via the core network or the RAN), and/or other suitable metrics. In some embodiments, NWDAF 101 may request, obtain, receive, etc. such QoS maintainability analytics information from OAM System 301 and/or some other suitable device or system. In some embodiments, determining and/or monitoring the QoS maintainability analytics information associated with a given QoS identifier may include determining a measure of deviation of some or all of the QoS maintainability analytics information to corresponding QoS thresholds associated with the QoS identifier.

In some embodiments, NWDAF 101 may monitor the QoS maintainability analytics information based on a QoS maintainability analytics request (e.g., as received at 604), such as a “request-response” type of request or a “subscription” type request. As discussed above, the request may specify certain parameters or conditions, such as a particular QoS identifier or other suitable index, value, pointer, etc. (e.g., a particular 5QI value, a particular NSSAI value, a particular DSCP value, etc.), a particular timeframe (e.g., a past or future timeframe), a location, and/or one or more other factors. As discussed above, the request may specify one or more weights to be applied to particular respective QoS maintainability analytics KPIs, such as a first weight to apply to a bitrate QoS maintainability analytics KPI, second weight to apply to a latency QoS maintainability analytics KPI, and/or a third weight to apply to a PER QoS maintainability analytics KPI.

Process 600 may further include determining (at 606) QoS maintainability analytics information for the parameters or conditions specified in the request. For example, NWDAF 101 may determine or predict QoS maintainability analytics information for a particular QoS identifier, a particular location, and/or a particular past or future timeframe.

Process 600 may also include generating (at 608) a QoS maintainability analytics report based on the QOS maintainability analytics request and based on the determined QoS maintainability analytics information for the parameters or conditions specified in the request. For example, NWDAF 101 may generate one or more scores based on the respective QoS maintainability analytics information and/or one or more weights specified in the request. As discussed above, the one or more scores may indicate or may be based on respective measures of deviation of the monitored QoS maintainability analytics KPIs from respective corresponding QoS thresholds associated with the particular QoS identifier.

Process 600 may further include providing (at 610) the QoS maintainability analytics report in response to the QoS maintainability analytics request (e.g., to a particular NF 103 and/or some other device or system from which the QoS maintainability analytics request was received). As discussed above, NWDAF 101 may provide the QoS maintainability analytics report when one or more reporting thresholds are met, and/or may provide the QoS maintainability analytics report as a one-time response to the QoS maintainability analytics request. As discussed above, NF 103, AF 501, and/or some other suitable device or system receiving the QoS maintainability analytics report may perform one or more reconfiguration operations or other suitable operations, in order to account for, mitigate, avoid, etc. potential QoS degradations at a given timeframe and/or location, thus ultimately enhancing the operation of the network and improving the user experience of services provided to UEs 505 via the wireless network.

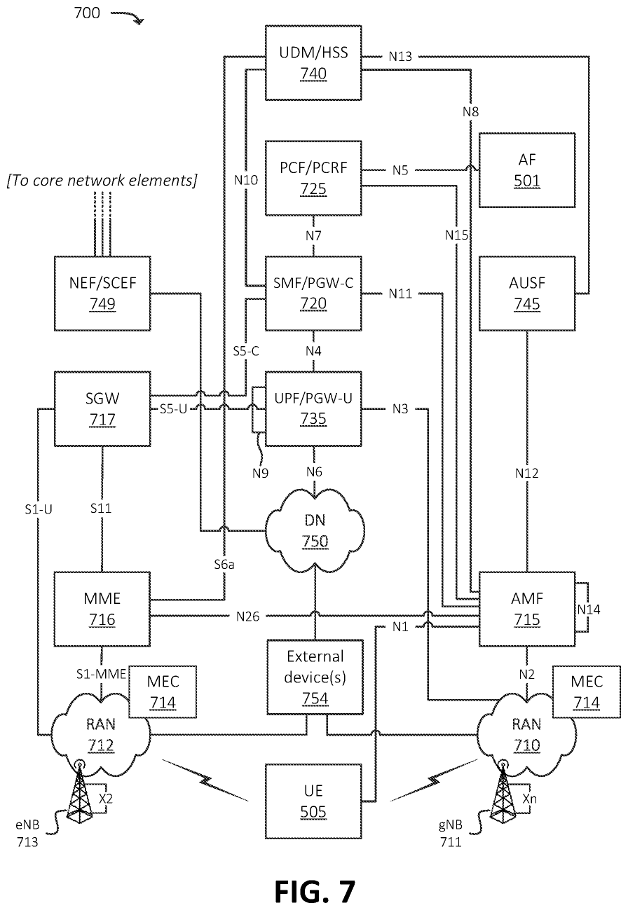

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 505, RAN 710 (which may include one or more Next Generation Node Bs (“gNBs”) 711), RAN 712 (which may include one or more evolved Node Bs (“eNBs”) 713), and various network functions such as AMF 715, Mobility Management Entity (“MME”) 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, AF 501, User Plane Function (“UPF”)/PGW-User plane function (“PGW-U”) 735, Unified Data Management (“UDM”)/Home Subscriber Server (“HSS”) 740, Authentication Server Function (“AUSF”) 745, and NEF/Service Capability Exposure Function (“SCEF”) 749. Environment 700 may also include one or more networks, such as Data Network (“DN”) 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions (“VNFs”), Cloud-Native Network Functions (“CNFs”), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes® application programming interface (“API”) or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, an Nnwdaf interface, and/or one or more other SBIs.

UE 505 may include a computation and communication device, such as a wireless mobile communication device that is capable of communicating with RAN 710, RAN 712, and/or DN 750. UE 505 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 505 may send traffic to and/or receive traffic (e.g., user plane traffic) from DN 750 via RAN 710, RAN 712, and/or UPF/PGW-U 735.

RAN 710 may be, or may include, a 5G RAN that implements a 5G RAT and that includes one or more base stations (e.g., one or more gNBs 711), via which UE 505 may communicate with one or more other elements of environment 700. UE 505 may communicate with RAN 710 via an air interface (e.g., as provided by gNB 711). For instance, RAN 710 may receive traffic (e.g., user plane traffic such as voice call traffic, data traffic, messaging traffic, etc.) from UE 505 via the air interface, and may communicate the traffic to UPF/PGW-U 735 and/or one or more other devices or networks. Further, RAN 710 may receive signaling traffic, control plane traffic, etc. from UE 505 via the air interface, and may communicate such signaling traffic, control plane traffic, etc. to AMF 715 and/or one or more other devices or networks. Additionally, RAN 710 may receive traffic intended for UE 505 (e.g., from UPF/PGW-U 735, AMF 715, and/or one or more other devices or networks) and may communicate the traffic to UE 505 via the air interface. In some embodiments, base station 407 may be, may include, and/or may be implemented by one or more gNBs 711. In some embodiments, RAN 710 may be, may include, may implement, and/or may be implemented by RAN 403.

RAN 712 may be, or may include, an LTE RAN that implements an LTE RAT and that includes one or more base stations (e.g., one or more eNBs 713), via which UE 505 may communicate with one or more other elements of environment 700. UE 505 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 505 via the air interface, and may communicate the traffic to UPF/PGW-U 735 (e.g., via SGW 717) and/or one or more other devices or networks. Further, RAN 712 may receive signaling traffic, control plane traffic, etc. from UE 505 via the air interface, and may communicate such signaling traffic, control plane traffic, etc. to MME 716 and/or one or more other devices or networks. Additionally, RAN 712 may receive traffic intended for UE 505 (e.g., from UPF/PGW-U 735, MME 716, SGW 717, and/or one or more other devices or networks) and may communicate the traffic to UE 505 via the air interface. In some embodiments, base station 407 may be, may include, and/or may be implemented by one or more eNBs 713. In some embodiments, RAN 712 may be, may include, may implement, and/or may be implemented by RAN 403.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing (“MEC”) devices (referred to sometimes herein simply as a “MECs”) 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 505, via RAN 710 and/or 712. For example, RAN 710 and/or 712 may route some traffic from UE 505 (e.g., traffic associated with one or more particular services, applications, application types, etc.) to a respective MEC 714 instead of to core network elements of 700 (e.g., UPF/PGW-U 735). MEC 714 may accordingly provide services to UE 505 by processing such traffic, performing one or more computations based on the received traffic, and providing traffic to UE 505 via RAN 710 and/or 712. MEC 714 may include, and/or may implement, some or all of the functionality described above with respect to UPF/PGW-U 735, AF 501, one or more application servers, and/or one or more other devices, systems, VNFs, CNFs, etc. In this manner, ultra-low latency services may be provided to UE 505, as traffic does not need to traverse links (e.g., backhaul links) between RAN 710 and/or 712 and the core network.

AMF 715 may include one or more devices, systems, VNFs, CNFs, etc., that perform operations to register UE 505 with the 5G network, to establish bearer channels associated with a session with UE 505, to hand off UE 505 from the 5G network to another network, to hand off UE 505 from the other network to the 5G network, manage mobility of UE 505 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 505 with the EPC, to establish bearer channels associated with a session with UE 505, to hand off UE 505 from the EPC to another network, to hand off UE 505 from another network to the EPC, manage mobility of UE 505 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 505. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 501 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 505, from DN 750, and may forward the user plane data toward UE 505 (e.g., via RAN 710, SMF/PGW-C 720, and/or one or more other devices). In some embodiments, multiple instances of UPF/PGW-U 735 may be deployed (e.g., in different geographical locations), and the delivery of content to UE 505 may be coordinated via the N9 interface (e.g., as denoted in FIG. 7 by the line marked “N9” originating and terminating at UPF/PGW-U 735). Similarly, UPF/PGW-U 735 may receive traffic from UE 505 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a Unified Data Repository (“UDR”). AUSF 745 and/or UDM/HSS 740 may perform authentication, authorization, and/or accounting operations associated with one or more UEs 505 and/or one or more communication sessions associated with one or more UEs 505.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 505 may communicate, through DN 750, with data servers, other UEs 505, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 505 may communicate.

External devices 754 may include one or more devices or systems that communicate with UE 505 via DN 750 and one or more elements of 700 (e.g., via UPF/PGW-U 735). External devices 754 may include, for example, one or more application servers, content provider systems, web servers, or the like. External devices 754 may, for example, implement “server-side” applications that communicate with “client-side” applications executed by UE 505. External devices 754 may provide services to UE 505 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy (“SEPP”), which may perform some or all of the functions discussed above. External device 754 may, in some situations, subscribe to particular types of requested information provided by the one or more core network elements, and the one or more core network elements may provide (e.g., “push”) the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, SLAs, etc. (e.g., maximum latency thresholds, minimum throughput thresholds, etc.) associated with the services.

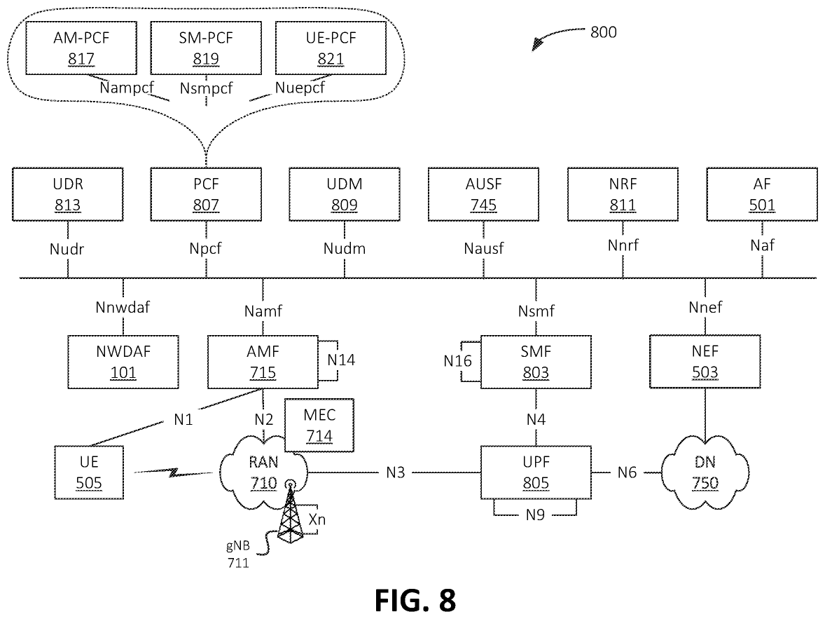

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 505, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function (“NRF”) 811, AF 501, UDR 813, NWDAF 101, and NEF 503. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs.

UPF 805 may include one or more devices, systems, VNFs, CNFs, etc., that receive, route, process, and/or forward traffic (e.g., user plane traffic). As discussed above, UPF 805 may communicate with UE 505 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 505) from DN 750, and may forward the downlink user plane traffic toward UE 505 (e.g., via RAN 710). In some embodiments, multiple UPFs 805 may be deployed (e.g., in different geographical locations), and the delivery of content to UE 505 may be coordinated via the N9 interface. Similarly, UPF 805 may receive uplink traffic from UE 505 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 505 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as access and mobility PCF (“AM-PCF”) 817, session management PCF (“SM-PCF”) 819, UE PCF (“UE-PCF”) 821, and so on. Such different “split” PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 503 include one or more devices, systems, VNFs, CNFs, etc. that provide access to information, APIs, and/or other operations or mechanisms of the 5GC to devices or systems that are external to the 5GC. NEF 503 may maintain authorization and/or authentication information associated with such external devices or systems, such that NEF 503 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function (“CHF”) of the 5GC, and/or other suitable network function. NEF 503 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 503 may include, may implement, may be implemented by, and/or may otherwise be associated with a SCEF (e.g., NEF/SCEF 749); and so on.

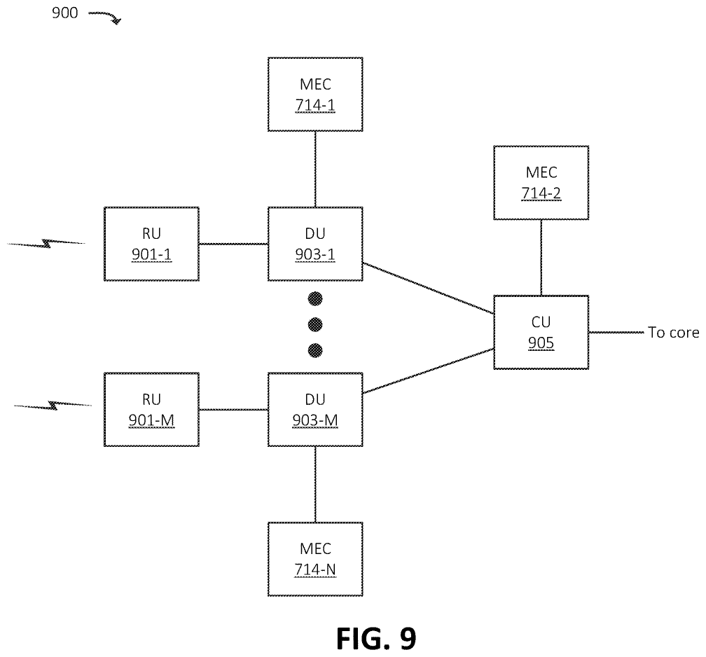

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-M (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 715 and/or UPF 805) and/or some other device or system such as MEC 714. In the uplink direction (e.g., for traffic from UEs 505 to a core network), CU 905 may aggregate traffic from DUs 903, and forward the aggregated traffic to the core network. In some embodiments, CU 905 may receive traffic according to a given protocol (e.g., Radio Link Control (“RLC”) traffic) from DUs 903, and may perform higher-layer processing (e.g., may aggregate/process RLC packets and generate Packet Data Convergence Protocol (“PDCP”) packets based on the RLC packets) on the traffic received from DUs 903.

CU 905 may receive downlink traffic (e.g., traffic from the core network, traffic from a given MEC 714, etc.) for a particular UE 505, and may determine which DU(s) 903 should receive the downlink traffic. DU 903 may include one or more devices that transmit traffic between a core network (e.g., via CU 905) and UE 505 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 505.

RU 901 may include hardware circuitry (e.g., one or more RF transceivers, antennas, radios, and/or other suitable hardware) to communicate wirelessly (e.g., via an RF interface) with one or more UEs 505, one or more other DUs 903 (e.g., via RUs 901 associated with DUs 903), and/or any other suitable type of device. In the uplink direction, RU 901 may receive traffic from UE 505 and/or another DU 903 via the RF interface and may provide the traffic to DU 903. In the downlink direction, RU 901 may receive traffic from DU 903, and may provide the traffic to UE 505 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 505, via a respective RU 901.

For example, DU 903-1 may route some traffic, from UE 505, to MEC 714-1 instead of to a core network via CU 905. MEC 714-1 may process the traffic, perform one or more computations based on the received traffic, and may provide traffic to UE 505 via RU 901-1. As discussed above, MEC 714 may include, and/or may implement, some or all of the functionality described above with respect to UPF 805, AF 501, and/or one or more other devices, systems, VNFs, CNFs, etc. In this manner, ultra-low latency services may be provided to UE 505, as traffic does not need to traverse DU 903, CU 905, links between DU 903 and CU 905, and an intervening backhaul network between RAN environment 900 and the core network.

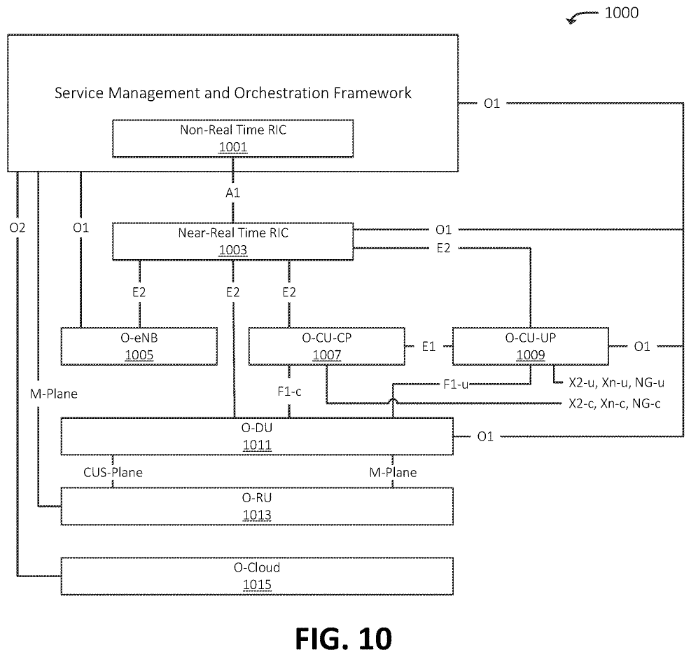

FIG. 10 illustrates an example O-RAN environment 1000, which may correspond to RAN 710, RAN 712, and/or RAN environment 900. For example, RAN 710, RAN 712, and/or RAN environment 900 may include one or more instances of O-RAN environment 1000, and/or one or more instances of O-RAN environment 1000 may implement RAN 710, RAN 712, RAN environment 900, and/or some portion thereof. As shown, O-RAN environment 1000 may include Non-Real Time RIC 1001, Near-Real Time RIC 1003, O-eNB 1005, O-CU-Control Plane (“O-CU-CP”) 1007, O-CU-User Plane (“O-CU-UP”) 1009, O-DU 1011, O-RU 1013, and O-Cloud 1015. In some embodiments, O-RAN environment 1000 may include additional, fewer, different, and/or differently arranged components or interfaces.

In some embodiments, some or all of the elements of O-RAN environment 1000 may be implemented by one or more configurable or provisionable resources, such as virtual machines, cloud computing systems, physical servers, and/or other types of configurable or provisionable resources. In some embodiments, some or all of O-RAN environment 1000 may be implemented by, and/or communicatively coupled to, one or more MECs 714.

Non-Real Time RIC 1001 and Near-Real Time RIC 1003 may receive performance information (and/or other types of information) from one or more sources, and may configure other elements of O-RAN environment 1000 based on such performance or other information. For example, Near-Real Time RIC 1003 may receive performance information, via one or more E2 interfaces, from O-eNB 1005, O-CU-CP 1007, and/or O-CU-UP 1009, and may modify parameters associated with O-eNB 1005, O-CU-CP 1007, and/or O-CU-UP 1009 based on such performance information. Similarly, Non-Real Time RIC 1001 may receive performance information associated with O-eNB 1005, O-CU-CP 1007, O-CU-UP 1009, and/or one or more other elements of O-RAN environment 1000 and may utilize machine learning and/or other higher level computing or processing to determine modifications to the configuration of O-eNB 1005, O-CU-CP 1007, O-CU-UP 1009, and/or other elements of O-RAN environment 1000. In some embodiments, Non-Real Time RIC 1001 may generate machine learning models based on performance information associated with O-RAN environment 1000 or other sources, and may provide such models to Near-Real Time RIC 1003 for implementation.

O-eNB 1005 may perform functions similar to those described above with respect to gNB 711 and/or eNB 713. For example, O-eNB 1005 may facilitate wireless communications between UE 505 and a core network. O-CU-CP 1007 may perform control plane signaling to coordinate the aggregation and/or distribution of traffic via one or more DUs 903, which may include and/or be implemented by one or more O-DUs 1011, and O-CU-UP 1009 may perform the aggregation and/or distribution of traffic via such DUs 903 (e.g., O-DUs 1011). O-DU 1011 may be communicatively coupled to one or more RUs 901, which may include and/or may be implemented by one or more O-RUs 1013. In some embodiments, O-Cloud 1015 may include or be implemented by one or more MECs 714, which may provide services, and may be communicatively coupled, to O-CU-CP 1007, O-CU-UP 1009, O-DU 1011, and/or O-RU 1013 (e.g., via an O1 and/or O2 interface).

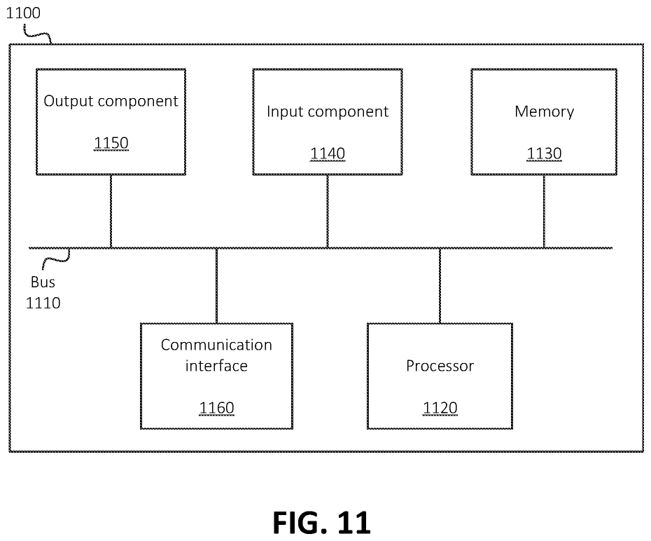

FIG. 11 illustrates example components of device 1100. One or more of the devices described above may include one or more devices 1100. Device 1100 may include bus 1110, processor 1120, memory 1130, input component 1140, output component 1150, and communication interface 1160. In another implementation, device 1100 may include additional, fewer, different, or differently arranged components.

Bus 1110 may include one or more communication paths that permit communication among the components of device 1100. Processor 1120 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1120 may be or may include one or more hardware processors. Memory 1130 may include any type of dynamic storage device that may store information and instructions for execution by processor 1120, and/or any type of non-volatile storage device that may store information for use by processor 1120.

Input component 1140 may include a mechanism that permits an operator to input information to device 1100 and/or other receives or detects input from a source external to input component 1140, such as a touchpad, a touchscreen, a keyboard, a keypad, a button, a switch, a microphone or other audio input component, etc. In some embodiments, input component 1140 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1150 may include a mechanism that outputs information to the operator, such as a display, a speaker, one or more light emitting diodes (“LEDs”), etc.

Communication interface 1160 may include any transceiver-like mechanism that enables device 1100 to communicate with other devices and/or systems (e.g., via RAN 710, RAN 712, DN 750, etc.). For example, communication interface 1160 may include an Ethernet interface, an optical interface, a coaxial interface, or the like. Communication interface 1160 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1100 may include more than one communication interface 1160. For instance, device 1100 may include an optical interface, a wireless interface, an Ethernet interface, and/or one or more other interfaces.

Device 1100 may perform certain operations relating to one or more processes described above. Device 1100 may perform these operations in response to processor 1120 executing instructions, such as software instructions, processor-executable instructions, etc. stored in a computer-readable medium, such as memory 1130. A computer-readable medium may be defined as a non-transitory memory device. A memory device may include space within a single physical memory device or spread across multiple physical memory devices. The instructions may be read into memory 1130 from another computer-readable medium or from another device. The instructions stored in memory 1130 may be processor-executable instructions that cause processor 1120 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A first device, comprising:
one or more processors configured to:
determine one or more QoS maintainability analytics associated with a particular Quality of Service (“QoS”) identifier over a particular timeframe, wherein the one or more QoS maintainability analytics include at least one of:
a measure of bitrate of traffic associated with the particular QoS identifier over the particular timeframe,
a measure of latency of the traffic associated with the particular QoS identifier over the particular timeframe, or
a packet error rate of the traffic associated with the particular QoS identifier over the particular timeframe;
receive, from a second device, a QoS maintainability analytics request associated with the particular timeframe, wherein the QoS maintainability analytics request specifies the particular QoS identifier;
generate a QoS maintainability analytics report based on the QoS maintainability analytics associated with the particular QoS identifier over the particular timeframe; and
provide the QOS maintainability analytics report to the second device, wherein the second device modifies one or more configuration parameters associated with one or more network services provided by the second device based on the QoS maintainability analytics report.

2. The first device of claim 1, wherein the first device includes a first Network Function (“NF”) of a wireless network, and wherein the second device includes a second NF of the wireless network.

3. The first device of claim 1, wherein the first device includes a Network Data Analytics Function (“NWDAF”) of a wireless network.

4. The first device of claim 1, wherein determining the one or more QoS maintainability analytics associated with the particular QoS identifier over the particular timeframe includes receiving the one or more QoS maintainability analytics from an Operations, Administration, and Maintenance (“OAM”) system.

5. The first device of claim 1,
wherein the particular QoS identifier is associated with at least one of a threshold bitrate, a threshold latency, or a threshold packet error rate,
wherein the QoS maintainability analytics report indicates at least one of:
a measure of deviation of bitrate of traffic associated with the particular QoS identifier from the threshold bitrate,
a measure of deviation of latency of the traffic associated with the particular QOS identifier from the threshold latency, or
a measure of deviation of packet error rate of the traffic associated with the particular QoS identifier from the threshold packet error rate.

6. The first device of claim 1, wherein the QoS maintainability analytics report is not based on a quantity of released flows associated with the particular QoS identifier.

7. The first device of claim 1, wherein the one or more processors are further configured to:
receive, from the second device, a request for a QoS sustainability report associated with the particular QoS identifier;
generate a QoS sustainability report based on:
the QoS maintainability analytics report, and
a quantity of released flows associated with the particular QoS identifier; and
output the QoS sustainability report to the second device.

8. A non-transitory computer-readable medium, storing a plurality of processor-executable instructions to:
determine one or more QoS maintainability analytics associated with a particular Quality of Service (“QoS”) identifier over a particular timeframe, wherein the one or more QoS maintainability analytics include at least one of:
a measure of bitrate of traffic associated with the particular QoS identifier over the particular timeframe,
a measure of latency of the traffic associated with the particular QoS identifier over the particular timeframe, or
a packet error rate of the traffic associated with the particular QoS identifier over the particular timeframe;
receive, from a device, a QoS maintainability analytics request associated with the particular timeframe, wherein the QoS maintainability analytics request specifies the particular QoS identifier;
generate a QoS maintainability analytics report based on the QoS maintainability analytics associated with the particular QoS identifier over the particular timeframe; and
provide the QoS maintainability analytics report to the device, wherein the device modifies one or more configuration parameters associated with one or more network services provided by the device based on the QoS maintainability analytics report.

9. The non-transitory computer-readable medium of claim 8, wherein the plurality of processor-executable instructions are executed by a first Network Function (“NF”) of a wireless network, and wherein the device includes a second NF of the wireless network.

10. The non-transitory computer-readable medium of claim 8, wherein the plurality of processor-executable instructions are executed by a Network Data Analytics Function (“NWDAF”) of a wireless network.

11. The non-transitory computer-readable medium of claim 8, wherein determining the one or more QoS maintainability analytics associated with the particular QoS identifier over the particular timeframe includes receiving the one or more QoS maintainability analytics from an Operations, Administration, and Maintenance (“OAM”) system.

12. The non-transitory computer-readable medium of claim 8,
wherein the particular QoS identifier is associated with at least one of a threshold bitrate, a threshold latency, or a threshold packet error rate,
wherein the QoS maintainability analytics report indicates at least one of:
a measure of deviation of bitrate of traffic associated with the particular QoS identifier from the threshold bitrate,
a measure of deviation of latency of the traffic associated with the particular QOS identifier from the threshold latency, or
a measure of deviation of packet error rate of the traffic associated with the particular QoS identifier from the threshold packet error rate.

13. The non-transitory computer-readable medium of claim 8, wherein the QoS maintainability analytics report is not based on a quantity of released flows associated with the particular QoS identifier.

14. The non-transitory computer-readable medium of claim 8, wherein the plurality of processor-executable instructions further include processor-executable instructions to:
receive, from the device, a request for a QoS sustainability report associated with the particular QoS identifier;
generate a QoS sustainability report based on:
the QoS maintainability analytics report, and
a quantity of released flows associated with the particular QoS identifier; and
output the QoS sustainability report to the device.

15. A method, comprising:
determining, by a first device, one or more QoS maintainability analytics associated with a particular Quality of Service (“QoS”) identifier over a particular timeframe, wherein the one or more QoS maintainability analytics include at least one of:
a measure of bitrate of traffic associated with the particular QoS identifier over the particular timeframe,
a measure of latency of the traffic associated with the particular QoS identifier over the particular timeframe, or
a packet error rate of the traffic associated with the particular QoS identifier over the particular timeframe;
receiving, from a second device, a QoS maintainability analytics request associated with the particular timeframe, wherein the QoS maintainability analytics request specifies the particular QoS identifier;
generating a QoS maintainability analytics report based on the QoS maintainability analytics associated with the particular QoS identifier over the particular timeframe; and
providing the QoS maintainability analytics report to the second device, wherein the second device modifies one or more configuration parameters associated with one or more network services provided by the second device based on the QoS maintainability analytics report.

16. The method of claim 15, wherein the first device includes a first Network Function (“NF”) of a wireless network, and wherein the second device includes a second NF of the wireless network.

17. The method of claim 15, wherein the first device includes a Network Data Analytics Function (“NWDAF”) of a wireless network.

18. The method of claim 15, wherein determining the one or more QoS maintainability analytics associated with the particular QoS identifier over the particular timeframe includes receiving the one or more QoS maintainability analytics from an Operations, Administration, and Maintenance (“OAM”) system.

19. The method of claim 15,
wherein the particular QoS identifier is associated with at least one of a threshold bitrate, a threshold latency, or a threshold packet error rate,
wherein the QoS maintainability analytics report indicates at least one of:
a measure of deviation of bitrate of traffic associated with the particular QoS identifier from the threshold bitrate,
a measure of deviation of latency of the traffic associated with the particular QOS identifier from the threshold latency, or
a measure of deviation of packet error rate of the traffic associated with the particular QoS identifier from the threshold packet error rate.

20. The method of claim 15, further comprising:
receiving, from the second device, a request for a QoS sustainability report associated with the particular QoS identifier;
generating a QoS sustainability report based on:
the QoS maintainability analytics report, and
a quantity of released flows associated with the particular QoS identifier; and
outputting the QOS sustainability report to the second device.
